(19) United States
(12) Patent Application Publication
(10) Pub. No.: US 2018/0179377 A1
(43) Pub. Date: Jun. 28, 2018

(54) IMPROVED POLY(ESTER) AND POLY(OLEFIN) BLENDS CONTAINING POLYESTER-ETHER

(71) Applicant: INVISTA NORTH AMERICA S.A R.L., WILMINGTON, DE (US)

(72) Inventors: Uwe BAYER, Gessertshausen (DE); Robert L. JONES, JR., Kingwood, TX (US); Eva-Marie LEUSCHNER, Augsburg (DE); Anne NEUBIG, Augsburg (DE)

(73) Assignee: INVISTA NORTH AMERICA S.A R.L., WILMINGTON, DE (US)

(21) Appl. No.: 15/736,319

(22) PCT Filed: Jun. 15, 2016
(86) PCT No.: PCT/US2016/037657

§ 371 Date: Dec. 14, 2017

Related U.S. Application Data
(60) Provisional application No. 62/182,212, filed on Jun. 19, 2015.

(51) Int. Cl. C08L 67/02; C08G 63/672; C08K 5/3435; C08K 5/13

(52) U.S. Cl. CPC C08L 67/025; C08G 63/672; C08K 5/3435; C08K 5/13; C08L 2203/10; C08L 2205/025; C08L 2201/14; C08L 2201/08; C08K 2201/012; C08K 2201/008

(57) ABSTRACT

The present disclosure relates to novel polyester-ether compositions and their use in polyester resins. Containers made from these novel polyester-ether compositions give improved oxygen barrier protection for the filled fluids while maintaining good visual properties of the containers.

### BACKGROUND

Polyesters have been replacing glass and metal packaging materials due to their lighter weight, decreased breakage compared to glass, and potentially lower cost. One major deficiency with standard polyesters, however, is its relatively high gas permeability. This curtails the shelf life of carbonated soft drinks and oxygen sensitive beverages or foodstuff such as beer, wine, tea, fruit juice, ketchup, cheese and the like. Organic oxygen scavenging materials have been developed partly in response to the food industry's goal of having longer shelf-life for packaged food. These oxygen scavenging materials are incorporated into at least a portion of the package and remove oxygen from the enclosed package volume which surrounds the product or which may leak into the package, thereby inhibiting spoilage and prolonging freshness.

Suitable oxygen scavenging materials include oxidizable organic polymers which may react with ingressing oxygen. One example of an oxidizable organic polymer is a polyether. The polyether is typically used as a polyester-ether copolymer and in low amounts of less than 10 weight percent of the packaging material. The polyester-ether is dispersed in the matrix polyester phase and interacts with a suitable oxygen scavenging catalyst that catalyzes the reaction of the ingressing oxygen with the polyether. Oxygen scavenging catalysts are typically transition metal compounds, for example an organic or inorganic salt of cobalt. Other examples include manganese, copper, chromium, zinc, iron and nickel.

Polyester containers comprising polyester-ethers and an oxygen scavenging catalyst show good oxygen barrier properties. However, polyethers are also lacking in stability. During preparation and processing the polyether-containing material into articles and containers, undesirable degradation products such as acetaldehyde, tetrahydrofuran, and other C₂- to C₄-molecules may be produced in various amounts. These side products can inter alia cause undesirable off-tastes in the product. The problem is aggravated by the presence of the transition metal oxygen scavenging catalyst. The oxygen scavenging catalyst may also catalyze polyether degradation reactions. However, the transition metal based oxygen scavenging catalyst may impart color to the resin and may catalyze unwanted degradation processes in the resin. Therefore, it is often desirable to minimize the amount of metal based oxygen scavenging catalysts.

The amount of degradation products may in turn be reduced by adding stabilizers to the resin blend. It is commonly believed that these stabilizers reduce the amount of degradation products by scavenging radicals generated during production of the resins and their processing to the final articles. However, the use of such stabilizers is considered to be problematic in its own way: Stabilizers are considered to attenuate all radical reactions. Since the oxygen scavenging reaction also involves a transition metal-catalyzed radical mechanism, the presence of such stabilizers is considered to also negatively affect the oxygen barrier properties. In other words, the use of stabilizers reduces side-products in the packaging material but also deteriorates the oxygen barrier properties. Therefore, the use of stabilizers is limited in practical application.

There is a need in the art to provide polyether-containing resins which have reduced amounts of degradation products such as acetaldehyde, tetrahydrofuran, and other C₂- to C₄-molecules and yet provide excellent oxygen-scavenging properties.

One method of addressing gas permeability involves incorporating an oxygen scavenger into the package structure itself. In such an arrangement, oxygen scavenging materials constitute at least a portion of the package, and these materials remove oxygen from the enclosed package volume which surrounds the product or which may leak into the package, thereby inhibiting spoilage and prolonging freshness in the case of food products.

Suitable oxygen scavenging materials include oxidizable organic polymers in which either the backbone or the side-chains of the polymer react with oxygen. Such oxygen scavenging materials are typically employed with a suitable catalyst, for example, an organic or inorganic salt of a transition metal such as cobalt.

One example of an oxidizable organic polymer is a polyether. The polyether is typically used as polyester-ether copolymer and in low amounts of less than 10 weight percent of the packaging material. Typically, the polyester-ether is dispersed in the polyester phase and forms discrete domains within this phase.

A more economical and marketable solution for providing oxygen barrier protection is much needed in the food packaging industry. An industrial practice is to add a copolyester-ether together with an oxidation catalyst to a standard bottle-grade resin. However, this approach is faced with the real problem of inadequate oxygen barrier protection.

A major disadvantage in the standard bottle-grade polyester resin compositions used in food packaging is that a typical transition metal level, cobalt for example, of about 80 ppm does not provide the necessary oxygen barrier protection. Worldwide, more than 95% of resin bottle producers use standard bottle grade polyester resin formulations and achieving improved oxygen barrier protection is highly desired. Inadequate oxygen barrier protection leads to product quality and off-taste issues for the consumers.

It may be possible to make significant oxygen barrier protection improvements by increasing the level of transition metal such as cobalt, for example, transition metal-based oxygen scavenging catalysts. However, increasing the transition metal levels may impact the visual appearance and properties for the food and beverage containers. For example, higher cobalt level could impart blue coloration to the otherwise clear containers. The problem, therefore, is to bring improvements to the oxygen barrier performance while not compromising the visual properties of the food and beverage containers.

The developed color due to increased levels of transition metal may be masked by using a colorant dye in the oxygen barrier composition, such as yellow dye in the case of blue coloration caused by higher cobalt levels. The problem in this approach is the presence and level of the colorant dye may further reduce the oxygen barrier protection for the containers. There is a need for compositions where the levels of transition metal-based oxygen scavenging catalyst and colorant dye are reasonably balanced to improve oxygen barrier protection along with good visual properties for the bottles. The present disclosure provides such balanced levels in the bottle formulation that gives marketable visual and oxygen barrier performance. In the present disclosure, the colorant dye level is selected in such a way that the oxygen barrier protection is not further deteriorated.

### SUMMARY

One aspect of the present disclosure is directed to a composition comprising a) a copolyester-ether, b) a monomeric, oligomeric or polymeric hindered amine light stabilizer (HALS) in an amount of ≥15 ppm to ≤20,000 ppm, on basis of the weight of the stabilizer in the composition, wherein the copolyester-ether comprises one or more polyester segments and one or more polyether segments, wherein the one or more polyether segments are present in an amount of about ≥5 to about ≤95 wt. % of the copolyester-ether; wherein the HALS is represented by the formula (I) or a mixture of compounds of formula (I),

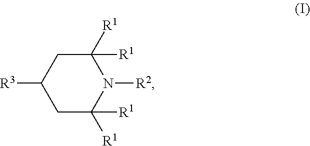

wherein each R¹ independently represents C₁-C₄ alkyl, R² represents H, C₁-C₄ alkyl, OH, O—C₁-C₄ alkyl, or a further part of an oligomeric or polymeric HALS, and R³ represents a further part of a monomeric, oligomeric or polymeric HALS, and c) the balance of a polyolefin functionalized to be [compatible] with the copolyester-ether.

Another aspect of the present disclosure is directed to a composition comprising a) a copolyester-ether, and b) an antioxidant, wherein the copolyester-ether comprises one or more polyester segments and one or more polyether segments, wherein the one or more polyether segments are present in an amount of about ≥5 to about 95 wt. % of the copolyester-ether.

Another aspect of the present disclosure is directed to an additive composition comprising:
a) no more than ≤75 parts by weight of a polyester and a polyolefin;
b) no less than ≥25 parts by weight of a copolyester-ether,
wherein the copolyester-ether comprises one or more polyester segments and one or more polyether segments, wherein the one or more polyether segments are present in an amount of about ≥5 to about ≤95 wt. % of the copolyester-ether;
c) a transition metal-based oxidation catalyst;
d) a monomeric, oligomeric or polymeric hindered amine light stabilizer (HALS) in an amount of ≥15 ppm to ≤20,000 ppm, preferably ≤10,000 ppm, on basis of the weight of the stabilizer in the total composition, wherein the HALS is represented by the formula (I) or a mixture of compounds of formula (I),

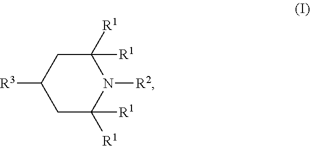

wherein each R¹ independently represents C₁-C₄ alkyl, R² represents H, C₁-C₄ alkyl, OH, O—C₁-C₄ alkyl, or a further part of an oligomeric or polymeric HALS, and R³ represents a further part of a monomeric, oligomeric or polymeric HALS; and
e) optionally, a colorant.

Another aspect of the present disclosure is directed to a method of improving oxygen barrier properties of an article comprising storing a preform comprising the composition as described in the specification, wherein the storage time is sufficient to observe an improvement in oxygen barrier properties.

### BRIEF DESCRIPTION OF THE FIGURES

FIG. 1 is a representation of an embodiment of the present disclosure.

FIG. 2 is a representation of an embodiment of the present disclosure.

### DETAILED DESCRIPTION

One aspect of the present disclosure is directed to a composition comprising a) a copolyester-ether, and b) a monomeric, oligomeric or polymeric hindered amine light stabilizer (HALS) in an amount of ≥15 ppm to 20,000 ppm, on basis of the weight of the stabilizer in the composition, wherein the copolyester-ether comprises one or more polyester segments and one or more polyether segments, wherein the one or more polyether segments are present in an amount of about ≥5 to about 95 wt. % of the copolyester-ether; wherein the HALS is represented by the formula (I) or a mixture of compounds of formula (I),

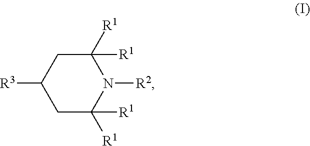

wherein each R¹ independently represents C₁-C₄ alkyl, R² represents H, C₁-C₄ alkyl, OH, O—C₁-C₄ alkyl, or a further part of an oligomeric or polymeric HALS, and R³ represents a further part of a monomeric, oligomeric or polymeric HALS.

Copolyester-ethers suitable for the present disclosure comprise one or more polyester segments and one or more polyether segments having a number-average molecular weight of from about ≥200 to about ≤5000 g/mol. In some embodiments, the polyether in the copolyester-ether may have a number-average molecular weight of from about ≥600 to about ≤3500 g/mol, and more specifically about ≥800 to about ≤3000 g/mol, that the copolyester-ether contains one or more polyether segments in an amount of about ≥5 to about ≤60 wt %, in particular about ≥10 to about ≤50 wt. %

In some embodiments, the polyether segments are present in the copolyester-ether in an amount of about ≥1.5 to about ≤45 wt. %.

Advantageously, the polyether segment is a poly (C₂-C₆-alkylene glycol) segment. The C₂-C₆-alkylene glycol may be a linear or branched aliphatic C₂-C₆-moiety. In some embodiments, the polyether segment is a linear or branched poly (C₂-C₆-alkylene glycol) segment.

Specific examples of such copolyester-ethers include poly(ethylene glycol), linear or branched poly(propylene glycol), linear or branched poly(butylene glycol), linear or branched poly(pentylene glycol), linear or branched poly(hexylene glycol) as well as mixed poly (C₂-C₆-alkylene glycols) obtained from two or more of the glycolic monomers used in preparing the before-mentioned examples. Advantageously, the polyether segment is a linear or branched poly(propylene glycol) or a linear or branched poly(butylene glycol). Compound having three hydroxyl groups (glycerols and linear or branched aliphatic triols could also be used.

The copolyester-ethers suitable for the present disclosure also comprise one or more polyester segments. The type of polyester in these segments is not particularly limited and can be any of the polyesters described in the specification. In one embodiment, the copolyester-ether comprises a polyethylene terephthalate (co)polymer segment. In another embodiment, the copolyester-ether comprises a polyethylene terephthalate (co)polymer segment and a linear or branched poly(butylene glycol) segment.

Methods of preparing polyethers and copolyester-ethers are well known in the art. For example, the copolyester-ether can be produced by ester interchange with the dialkyl ester of a dicarboxylic acid. In the ester interchange process dialkyl esters of dicarboxylic acids undergo transesterification with one or more glycols in the presence of a catalyst such as zinc acetate as described in WO 20101096459 A2, incorporated herein by reference. A suitable amount of elemental zinc in the copolyester-ether can be about ≥35 ppm to about ≤100 ppm, for example about ≥40 ppm to about ≤80 ppm, by weight of the copolyester-ether. The poly(alkylene oxide) glycols replace part of these glycols in these transesterification processes. The poly(alkylene oxide) glycols can be added with the starting raw materials or added after transesterification. In either case, the monomer and oligomer mixture can be produced continuously in a series of one or more reactors operating at elevated temperature and pressures at one atmosphere or lesser. Alternatively, the monomer and oligomer mixture can be produced via the acid process in one or more batch reactors.

Next, the mixture of copolyester-ether monomer and oligomers undergoes melt-phase polycondensation to produce a polymer. The polymer is produced in a series of one or more reactors operating at elevated temperatures. To facilitate removal of excess glycols, water, and other reaction products, the polycondensation reactors are run under a vacuum.

Catalysts for the polycondensation reaction include compounds of antimony, germanium, tin, titanium and/or aluminum. Reaction conditions for polycondensation can include (i) a temperature less than about ≤290° C., or about 10° C. higher than the melting point of the copolyester-ether; and (ii) a pressure of less than about ≤0.01 bar, decreasing as polymerization proceeds. This copolyester-ether can be produced continuously in a series of one or more reactors operating at elevated temperature and pressures less than one atmosphere.

Alternatively this copolyester-ether can be produced in one or more batch reactors. The intrinsic viscosity after melt phase polymerization can be in the range of about ≥0.4 dl/g to about ≤1.5 dl/g. Antioxidants and other additives can be added before and/or during polymerization to control the degradation of the polyester-ether segments.

Alternatively, the copolyester-ethers can be produced by reactive extrusion of the polyether with the polyester. In the above-described methods of preparing the copolyester-ethers, it may happen that the polyether does not fully react with the polyester but is partly present as an intimate blend of the polyester and polyether. Therefore, throughout the specification and embodiments, the reference to a copolyester-ether comprising one or more polyester segments and one or more polyether segments is to be understood as referring to the respective copolyester-ethers, blends of respective polyesters and polyethers, and mixtures comprising both the respective copolyester-ethers and blends of the respective polyesters and polyethers.

In some embodiments, the HALS may be a polymeric HALS wherein R³ in above formula (I) may represent the polymer backbone of the polymeric HALS, such as Uvinul® 5050 for example. In other embodiments, R² in above formula (I) may represent a further part of an oligomeric or polymeric HALS, the piperidine ring in above formula (I) is part of the repeat unit of the oligomeric or polymeric HALS, such as Uvinul® 5062. In some other embodiments, the HALS may be a mixture of compounds of above formula (I), such as Uvinul® 4092. Other suitable HALSs include but are not limited to Uvinul® 4077, Uvinul® 4092, Nylostab®, Tinuvin®, Hostavin® and Nylostab® S-EED®.

In some embodiments, the HALS may be a monomeric HALS or a mixture there of. In other embodiments, the HALS may have a molecular weight of about ≥200 g/mol or above, about 400 g/mol to about ≤5000 g/mol, or about ≥400 to about ≤4000 g/mol, or in particular about ≥600 to about ≤2500 g/mol. An example of such HALS is Uvinul® 4050.

In some embodiments of the present disclosure, the HALS may be used in an amount of about ≥15 ppm to about ≤20,000 ppm, or about ≥20 ppm to about ≤15,000 ppm, or about ≥100 ppm to about ≤10,000 ppm, respective to the weight of the blend composition used in the preform.

In some embodiment, the composition further comprises an antioxidant.

Suitable examples of antioxidants include, but are not limited to, phenolic antioxidants, aminic antioxidants, sulfur-based antioxidants and phosphites, and mixtures thereof. Non-limiting examples of antioxidants are described in a published journal article titled “Antioxidants for poly(ethylene terephthalate)” in Plastics Additives, Pritchard, G., Ed. Springer Netherlands: 1998; Vol. 1, pp 95-107.

In some embodiments, the copolyester-ether may comprise of an antioxidant in an amount of up to about 3000 ppm by weight, in particular up to about 2000 ppm by weight, more specifically up to about 1000 ppm by weight, relative to the total copolyester-ether weight. Non-limiting examples of such antioxidants include butylated hydroxytoluene (BHT), Ethanox® 330, Ethanox® 330G, IRGANOX 1330, Hostanox® PEP-Q, and mixtures thereof.

In some embodiments, the antioxidant may be selected from the group consisting of hindered phenols, sulfur-based antioxidants, hindered amine light stabilizers and phosphites. In a further embodiment, the antioxidant may be selected from the group consisting of hindered phenols, sulfur-based antioxidants and phosphites. Examples of such antioxidants include, but are not limited to 1,3,5-trimethyl-2,4,6-tris(3,5-di-tert-butyl-4-hydroxybenzyl)-benzene (CAS: 1709-70-2), tetrakis(2,4-di-tert-butylphenyl)-1,1-biphenyl-4,4′-diylbisphosphonite (CAS: 38613-77-3) or pentaerythritol tetrakis(3-(3,5-di-tert-butyl-4-hydroxyphenyl)propionate (CAS: 6683-19-8), (5R)-[(1S)-1,2-Dihydroxyethyl]-3,4-dihydroxyfuran-2(5H)-one (Ascorbic acid CAS: 50-81-7); α-tocopherol (vitamin E form antioxidant agent. CAS: 59-02-9).

In certain embodiments, the antioxidant is a hindered phenol. In a further embodiment, the antioxidant is

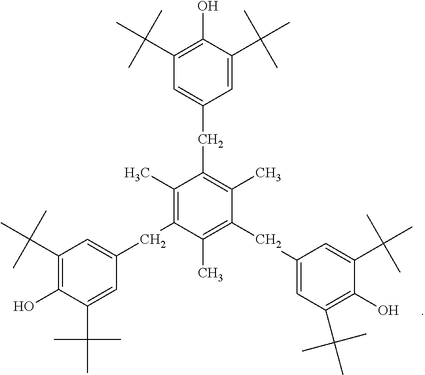 [SMILES: Cc1c(Cc2cc(C(C)(C)C)c(O)c(C(C)(C)C)c2)c(C)c(Cc2cc(C(C)(C)C)c(O)c(C(C)(C)C)c2)c(C)c1Cc1cc(C(C)(C)C)c(O)c(C(C)(C)C)c1]

Another aspect of the present disclosure is directed to a composition comprising a) a copolyester-ether, and b) an antioxidant, wherein the copolyester-ether comprises one or more polyester segments and one or more polyether segments, wherein the one or more polyether segments are present in an amount of about 5 to about 95 wt. % of the copolyester-ether.

The copolyester-ether and the antioxidant are as described above.

In certain embodiments, the polyether segment is a linear or branched poly (C₂-C₆-alkylene glycol) segment.

In some embodiments, the polyether segment has a number-average molecular weight of about ≥200 to about ≤5000 g/mol, preferably about ≥600 to about ≤3500 g/mol.

In one embodiment, wherein the polyether segments are present in the copolyester-ether in an amount of about ≥15 to about ≤45 wt. %. In another embodiment, the copolyester-ether comprises a polyethylene terephthalate (co)polyester segment.

Another aspect of the present disclosure is directed to an additive composition comprising:

a) no more than ≤75 parts by weight of a polyester;

b) no less than ≥25 parts by weight of a copolyester-ether,

wherein the copolyester-ether comprises one or more polyester segments and one or more polyether segments, wherein the one or more polyether segments are present in an amount of about ≥5 to about ≤95 wt.-% of the copolyester-ether;

c) a transition metal-based oxidation catalyst;

d) a monomeric, oligomeric or polymeric hindered amine light stabilizer (HALS) in an amount of ≥15 ppm to ≤20000 ppm, preferably ≤10000 ppm, on basis of the weight of the stabilizer in the total composition, wherein the HALS is represented by the formula (I) or a mixture of compounds of formula (I),

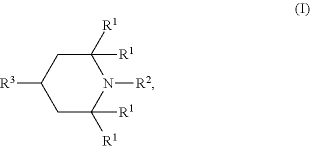

wherein each R¹ independently represents C₁-C₄ alkyl, R² represents H, C₁-C₄ alkyl, OH, O—C₁-C₄ alkyl, or a further part of an oligomeric or polymeric HALS, and R³ represents a further part of a monomeric, oligomeric or polymeric HALS; and

e) optionally, a colorant.

In some embodiments, the additive composition comprises no more than 75 parts, no more than ≤70 parts, no more than ≤65 parts, no more than ≤60 parts, all by weight of a polyester. In other embodiments, the additive composition comprises a polyester component from about ≥25 to about ≤75 wt. %, from about ≥30 to about ≤70 wt. %, from about ≥35 to about ≤65 wt. %, from about ≥40 to about ≤60 wt. %, relative to the total weight of the additive composition.

In some embodiments, the additive composition comprises no less than ≤25 parts, no less than ≤30 parts, no less than ≤35 parts, no less than ≤40 parts; all by weight of a copolyester-ether. In other embodiments, the additive composition comprises a copolyester-ether component from about ≥25 to about ≤75 wt. %, from about ≥30 to about ≤70 wt. %, from about ≥35 to about ≤65 wt. %, from about ≥40 to about ≤60 wt. %, relative to the total weight of the additive composition.

Generally, polyesters suitable for the present disclosure can be prepared by processes, namely, and not limited to (1) the ester process and (2) the acid process. The ester process is where a dicarboxylic ester (such as dimethyl terephthalate) is reacted with ethylene glycol or other diol in an ester interchange reaction. Catalysts for use in the ester interchange reaction are well known and may be selected from manganese, zinc, cobalt, titanium, calcium, magnesium or lithium compounds. Because the reaction is reversible, it is generally necessary to remove the alcohol (e.g. methanol when dimethyl terephthalate is employed) to completely convert the raw materials into monomers. The catalytic activity of the interchange reaction catalyst may optionally be sequestered by introducing a phosphorus compound, for example polyphosphoric acid, at the end of the ester interchange reaction. Then the monomer undergoes polycondensation. The catalyst employed in this reaction is typically an antimony, germanium, aluminum, zinc, tin or titanium compound, or a mixture of these. In some embodiments, it may be advantageous to use a titanium compound.

In the second method for making polyester, an acid (such as terephthalic acid) is reacted with a diol (such as ethylene glycol) by a direct esterification reaction producing monomer and water. This reaction is also reversible like the ester process and thus to drive the reaction to completion one must remove the water. The direct esterification step does not require a catalyst. The monomer then undergoes polycondensation to form polyester just as in the ester process, and the catalyst and conditions employed are generally the same as those for the ester process. In summary, in the ester process there are two steps, namely: (1) an ester interchange, and (2) polycondensation. In the acid process there are also two steps, namely: (1) direct esterification, and (2) polycondensation.

Suitable polyesters can be aromatic or aliphatic polyesters, and are preferably selected from aromatic polyesters. An aromatic polyester is preferably derived from one or more diol(s) and one or more aromatic dicarboxylic acid(s). The aromatic dicarboxylic acid includes, for example, terephthalic acid, isophthalic acid, 1,4-, 2,5-, 2,6- or 2,7-naphthalenediearboxylic acid and 4,4′-diphenyldicarboxylic acid (and of these terephthalic acid is preferred). The diol is preferably selected from aliphatic and cycloaliphatic diol(s), including, for example, ethylene glycol, 1,4-butanediol, 1,4-cyclohexane dimethanol, and 1,6-hexanediol (and of these, aliphatic diols, and preferably ethylene glycol, is preferred). Preferred polyesters are polyethylene terephthalate (PET) and polyethylene-2,6-naphthalene dicarboxylate (also referred to herein as polyethylene-2,6-naphthalate), and particularly preferred is PET.

Examples of suitable polyesters include those produced from the reaction of a diacid or diester component comprising at least ≥65 mol % aromatic diacid (preferably terephthalic acid) or the C₁-C₄ dialkyl ester of the aromatic acid (preferably C₁-C₄ dialkylterephthalate), for example at least ≥70 mol % or at least ≥75 mol % or at least ≥95 mol %, with a diol component comprising at least ≥65 mol % dial (preferably ethylene glycol), for example at least ≥70 mol % or at least ≥75 mol % or at least ≥95 mol %. Exemplary polyesters include those wherein the diacid component is terephthalic acid and the diol component is ethylene glycol, thereby forming polyethylene terephthalate (PET). The mole percent for all the diacid components totals 100 mol %, and the mole percentage for all the diol components totals 100 mol %.

The polyester may be modified by one or more diol components other than ethylene glycol. In this case, the polyester is a copolyester. Suitable diol components of the described polyester may be selected from 1,4-cyclohexane-dimethanol, 1,2-propanediol, 1,4-butanediol, 2,2-dimethyl-1,3-propanediol, 2-methyl-1,3-propanediol (2MPDO) 1,6-hexanediol, 1,2-cyclo-hexanediol, 1,4-cyclohexanediol, 1,2-cyclohexanedimethanol, 1,3-cyclohexanedimethanol, and diols containing one or more oxygen atoms in the chain, e.g., diethylene glycol, triethylene glycol, dipropylene glycol, tripropylene glycol or mixtures of these, and the like. In general, these diols contain 2 to 18, preferably 2 to 8 carbon atoms. Cycloaliphatic diols can be employed in their cis- or trans-configuration or as mixture of both forms. Suitable modifying diol components can be 1,4-cyclohexanedimethanol or diethylene glycol, or a mixture of these.

The polyester may be modified by one or more acid components other than terephthalic acid. In this case, the polyester is a copolyester. Suitable acid components (aliphatic, alicyclic, or aromatic dicarboxylic acids) of the linear polyester may be selected, for example, from isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, 2,6-naphthalene-dicarboxylic acid, bibenzoic acid, or mixtures of these and the like. In the polymer preparation, it is possible to use a functional acid derivative of the above acid components. Typical functional acid derivatives include the dimethyl, diethyl, or dipropyl ester of the dicarboxylic acid or its anhydride.

In some embodiments, the polyester is a copolyester of ethylene glycol with a combination of terephthalic acid and isophthalic acid and/or metal salt of 5-sulfoisophthalic acid. In other embodiments, the isophthalic acid can be present from about ≥0.05 mol % to about ≤10 mol % and the metal salt of 5-sulfoisophthalic acid can be present from about ≥0.1 mol % to about ≤3 mol % of the copolymer. The metal in the 5-sulfoisophthalic acid metal salt may be lithium, sodium, potassium, zinc, magnesium and calcium, as described in U.S Patent Application No. 20130053593 A1, incorporated herein by reference.

In some embodiments, the polyester may be selected from polyethylene terephthalate, polyethylene naphthalate, polyethylene isophthalate, copolymers of polyethylene terephthalate, copolymers of polyethylene naphthalate, copolymers of polyethylene isophthalate, or mixtures thereof; for example the polyester can be a copolymer of polyethylene terephthalate, such as poly(ethylene terephthalate-co-ethylene isophthalate) or poly(ethylene terephthalate-eo-ethylene 5-sulfoisophthalate) or poly(ethylene terephthalate-co-ethylene isophthalate-co ethylene 5-sulfoisophatnalte metal salt).

The term “transition metal”, as used in the present disclosure, means any of the set of metallic elements occupying Groups IVB-VIII, IB, and IIB, or 4-12 in the periodic table of elements. Non-limiting examples are cobalt, manganese, copper, chromium, zinc, iron, nickel, and combinations thereof. The transition metals have variable chemical valence and a strong tendency to form coordination compounds.

Where the disclosure may further comprise a transition metal-based oxidation catalyst, suitable oxidation catalysts include those transition metal catalysts that activate or promote the oxidation of the copolyester-ether by ambient oxygen. Examples of suitable transition metal catalysts may include compounds comprising cobalt, manganese, copper, chromium, zinc, iron, or nickel. It is also possible that the transition metal catalyst is incorporated in the polymer matrix during extrusion for example. The transition metal catalyst can be added during polymerization of the polyester or compounded into a suitable polyester thereby forming a polyester-based masterbatch that can be added during the preparation of the article. The transition metal compound, such as a cobalt compound for example, may be physically separate from the copolyester-ether, for example a sheath core or side-by-side relationship, so as not to activate the copolyester-ether prior to melt blending into a preform or bottle.

In some embodiments, the transition metal-based oxidation catalyst may include, but are not limited to, a transition metal salt of i) a metal comprising at least one member selected from the group consisting of cobalt, manganese, copper, chromium, zinc, iron, and nickel and ii) a counter ion comprising at least one member selected from the group of carboxylate, such as neodecanoates, octanoates, stearates, acetates, naphthalates, lactates, maleates, acetylacetonates, linoleates, oleates, palminates or 2-ethyl hexanoates, oxides, carbonates, chlorides, dioxides, hydroxides, nitrates, phosphates, sulfates, silicates or mixtures thereof.

In some embodiments, the transition metal-based oxidation catalyst is a cobalt compound. In the container- or preform-related embodiments of the present disclosure, it may be advantageous that the transition metal-based oxidation catalyst is a cobalt compound that is present in an amount such that the weight of the cobalt metal in the blend composition for preparing an article, preform or container is at least about ≥80 ppm by weight, at least about ≥85 ppm, at least about ≥90 ppm, at least about ≥95 ppm, at least about ≥100 ppm, relative to the total weight of blend composition.

In some embodiments, the transition metal-based oxidation catalyst is a cobalt compound that is present in an amount such that the weight of the cobalt metal in the blend composition for preparing an article, preform or container is about ≥80 to about ≤1000 ppm, about ≥80 to about ≤800 ppm, about ≥80 to about ≤600 ppm, about ≥90 to about ≤500 ppm, about ≥90 to about ≤400 ppm, about ≥90 to about ≤300 ppm, and more specifically about ≥90 to about ≤250 ppm or about ≥100 to about ≤200 ppm.

In some embodiments of the present disclosure, it may be advantageous that the transition metal-based oxidation catalyst is a cobalt compound that is present in an amount such that the weight of the cobalt metal in the additive composition is about ≥50 to about ≤10,000 ppm, about ≥100 to about ≤9,000 ppm, about ≥150 to about ≤8,000 ppm, more specifically about ≥200 to about ≤6,000 ppm, on basis of the weight of cobalt in the additive composition.

In other embodiments, it may be advantageous that the transition metal-based oxidation catalyst is a cobalt compound that is present in an amount such that the weight of the cobalt metal in the additive composition is at least about ≥1,000 ppm, at least about ≥1,100 ppm, at least about ≥1,200 ppm, at least about ≥1,300 ppm, at least about ≥1,400 ppm, at least about ≥1,500 ppm, at least about ≥1,600 ppm, at least about ≥1,700 ppm, at least about ≥1,800 ppm, at least about ≥1,900 ppm, at least about ≥2,000 ppm, more specifically at least about ≥2,100 ppm, on basis of the weight of cobalt in the additive composition.

In the embodiments of the present invention, the transition metal-based oxidation catalyst may be a cobalt salt, in particular a cobalt carboxylate, and especially a cobalt C₈-C₂₀ carboxylate. The cobalt compound may be physically separate from the copolyester-ether, for example a sheath core or side-by-side relationship, so as not to activate the copolyester-ether prior to melt blending into a container.

The term “colorant”, as used herein, can be an organic or inorganic chemical compound that is capable of imparting coloration to a substance, including masking, balancing or countering the absorbance of a substance in the 300-600 nm wavelength. It may be possible to use colorants such as inorganic pigments, for example, iron oxide, titanium oxide and Prussian Blue, and organic colorants such as alizarin colorants, azo colorants and metal phthalocyanine colorants, and trace nutrients such as salts of iron, manganese, boron, copper, cobalt, molybdenum and zinc. It may be advantageous for the colorants to have good thermal and chemical stability.

In some embodiments, the colorant may comprise of industrial, commercial and developmental class of pigments, dyes, inks, paint, and combinations thereof. In other embodiments, the colorant may comprise of synthetic, natural, bio-derived compounds and combinations thereof. In some other embodiments, the colorant may comprise of chemical compounds from a class of hetero-aromatic compounds.

In some embodiments, the colorant may comprise of an organic pigment or color dye. In other embodiments, the colorant may be chosen from a class of dyes, including organic polymer soluble dyes. In some other embodiments, the colorant may be a yellow dye, red dye, blue dye, and combinations thereof. In certain embodiments, the colorant may comprise a substituted Hydroxyquinolin-indene-dione nucleus substituted in such a way as to produce an absorption range in the yellow part of the visible spectrum (˜420-430 nm wavelength).

Examples of colorants may include, but not limited to, one or more dyes selected from the group consisting of Solvaperm Blue B, Solvaperm Green G, Polysynthren Yellow GG, Polysynthren Violet G, Polysynthren Blue R, Solvaperm Yellow 2G, Solvaperm Orange G, Solvaperm Red G, Solvaperm Red GG, Solvaperm Red Violet R, PV Fast Red E5B 02, PV Fast Pink E, PV Fast Blue A2R, PV Fast Blue B2G 01, PV Fast Green GNX, PV Fast Yellow HG, PV Fast Yellow HGR, PV Fast Yellow H3R, PV Red HG VP 2178, Polysynthren Brown R, Hostasol Yellow 3G, Hostasol Red GG, and Hostasol Red 5B.

Suitable examples of the colorant include, but are not limited to, polysynthrene Blue RLS (CAS No. 23552-74-1), Macrolex Red 5B (CAS No. 81-39-0), Solvaperm Yellow 2G (CAS No. 7576-65-0), and mixtures thereof.

In certain embodiments, the colorant is selected from the group consisting of a yellow dye, red dye, and blue dye. In a further embodiment, the colorant is a yellow dye. In another further embodiment, the yellow dye is Solvaperm Yellow 2G.

In certain embodiments, the colorant is present in the additive composition in an amount up to ≤500 ppm by weight. In a further embodiment, the colorant is present in the additive composition in an amount up to ≤400 ppm by weight. In some embodiments, the colorant is present in the additive composition in an amount up to ≤300 ppm by weight. In a further embodiment, the colorant is present in the additive composition in an amount up to ≤200 ppm by weight.

In some embodiment, the composition further comprises an antioxidant. The antioxidant is as described above.

In some embodiments, a blend composition comprising the additive composition as described above, a base polyester, and optionally, a second colorant.

As used herein, the term “base polyester” refers to a polyester component which is the predominant component of the total composition, e.g., used in excess of 50 wt % of the total composition, in particular in excess of 80 wt %, and more specifically in excess of 90 wt %.

The base polyester can be same or different from the polyester as described in the additive composition above. The second optional colorant can be same or different from the first optional colorant.

In other embodiments, the colorant is present in the blend composition in an amount up to ≤525 ppm by weight. In a further embodiment, the colorant is present in the composition in an amount up to ≤520 ppm by weight. In some embodiments, the colorant is present in the composition in an amount up to ≤15 ppm by weight, preferably in an amount up to ≤10 ppm by weight.

In some embodiments, the blend composition comprising ≥80-≤98.5 parts by weight of the polyester and the base polyester; ≥0.5-≤20 parts by weight of the copolyester-ether, the monomeric, oligomeric or polymeric HALS in an amount of ≥15 ppm to ≤20000, preferably ≤10,000 ppm, on basis of the weight of the stabilizer in the blend composition.

In certain embodiments, the transition metal is present in the blend composition in an amount of at least about ≥80 ppm by weight, at least about ≥85 ppm, at least about ≥90 ppm, at least about ≥95 ppm, at least about ≥100 ppm, relative to the total weight of blend composition.

In other embodiments, the copolyester-ethers are present in the blend composition in an amount from ≥0.5-≤20 parts by weight, including ≥0.5-≤15 parts by weight, ≥0.5-≤10 parts by weight, and ≥0.5-≤5 parts by weight. Preferably, the composition comprises ≥0.5-≤10 parts by weight of the copolyester-ethers.

In some embodiments, the one or more polyether segments may be present in an amount of about ≥5 to about ≤60 wt % of the copolyester-ether. In other embodiments, the polyether segments may be present in an amount of about ≥10 to about ≤50 wt %, more specifically about ≥15 to about ≤50 wt %, or in particular about ≥15 to about ≤45 wt %, in all cases based on the copolyester-ether.

In some embodiments, copolyester-ethers suitable for the present disclosure comprise one or more polyether segments in amounts so that the weight ratio of the one or more polyether segments to the total amount of base polyester and polyester segments in the additive composition is about ≥0.2 to about ≤15 wt %, more specifically about ≥0.3 to about ≤10 wt %, or in particular about ≥0.4 to about ≤5 wt %, or about ≥0.5 to about ≤2.5 wt % or about ≥0.5 to about ≤2 wt %.

The copolyester-ether is preferably used in amounts of about ≥0.2 to about ≤20 wt % in relation to the blend composition. In some embodiments, the amount of the copolyester-ether is selected within the range of about ≥0.2 to about ≤15 wt %, in relation to the blend composition, so that the amount of polyether segments to the total amount of base polyester and polyester segments in the blend composition is about ≥0.3 to about ≤10 wt %, more specifically about ≥0.4 to about ≤5 wt %, or in particular about ≥0.5 to about ≤2.5 wt %, or about ≥0.5 to about ≤2 wt %.

In some embodiments, the copolyester-ether contains one or more polyether segments in an amount of about ≥5 to about ≤60 wt %, in particular about ≥10 to about 50 wt %, more specifically about ≥15 to about ≤50 wt %, and also in particular about ≥15 to about ≤45 wt %, and that the amount of the copolyester-ether is selected so that the amount of polyether segments to the total amount of base polyester and polyester segments in the blend composition is about ≥0.3 to about ≤10 wt %, in particular about ≥0.4 to about ≤5 wt %, or about ≥0.5 to about ≤2.5 wt %, or about ≥0.5 to about ≤2 wt %.

In some embodiments, the polyether segments in the copolyester-ether may have a number-average molecular weight of from about ≥200 to about ≤5000 g/mol, in particular about ≥600 to about ≤3500 g/mol, that the copolyester-ether contains one or more polyether segments in an amount of about ≥5 to about ≤60 wt %, in particular about ≥10 to about ≤50 wt %, and that the amount of the copolyester-ether is selected within the range of about ≥15 to about ≤45 wt %, in relation to the additive composition, so that the amount of polyether segments to the total amount of base polyester and polyester segments in the blend composition is about ≥0.2 to about ≤15 wt %, or about ≥0.3 to about ≤10 wt %, in particular about ≥0.4 to about ≤5 wt %, or about ≥0.5 to about ≤2.5 wt %, or about ≥0.5 to about ≤2 wt %.

In some embodiments, the polyether segments in the copolyester-ether are selected from a linear or branched poly(propylene glycol) or a linear or branched poly(butylene glycol) having a number-average molecular weight of from about ≥200 to about ≤5000 g/mol, in particular about ≥600 to about ≤3500 g/mol, that the copolyester-ether contains one or more polyether segments in an amount of about ≥5 to about ≤60 wt %, or about ≥10 to about ≤50 wt %, in particular about ≥20 to about ≤45 wt %, relative to the additive composition, and that the amount of the copolyester-ether is selected within the range of about ≥0.2 to about ≤15 wt %, in relation to the blend composition, so that the amount of polyether segments to the total amount of base polyester and polyester segments in the blend composition is about ≥0.3 to about ≤10 wt %, in particular about ≥0.4 to about ≤5 wt %, or about ≥0.5 to about ≤2.5 wt %, or about ≥0.5 to about ≤2 wt %.

Another aspect of the present disclosure is directed to a method of improving oxygen barrier properties of an article comprising storing a preform comprising any compositions as described above under suitable storage conditions, wherein the storage time is sufficient to observe an improvement in oxygen barrier properties.

In one embodiment, the storage time is at least 1 day. In other embodiments, the storage for at least 2 days, at least 3 days, at least 4 days, at least 5 days, at least 6 days, or at least 7 days.

In certain embodiments, the term “storage condition”, means the condition to which a material is exposed while stored before use. For example, the storage condition used may include ambient temperatures, pressures and relative humidity. Other non-limiting examples of the storage condition may include, controlled or uncontrolled spatial climates to attain cooler than ambient temperatures, pressurized or de-pressurized environments, dry or moist surroundings, and combinations thereof. In certain embodiments, the storage condition may include ventilated or un-ventilated space, indoor, outdoor, and combinations thereof. It may also be possible to attain inert environments by providing an oxygen-deficient atmosphere for storage. In certain examples of the present disclosure, the storage conditions used are indoors, 20-25° C. temperature, ambient pressure and 70-95% relative humidity.

Embodiments in some aspects of the disclosure may further comprise additives selected from the group consisting of dyes, pigments, fillers, branching agents, reheat agents, anti-blocking agents, anti-static agents, biocides, blowing agents, coupling agents, anti-foaming agents, flame retardants, heat stabilizers, impact modifiers, crystallization aids, lubricants, plasticizers, processing aids, buffers, and slip agents. Representative examples of such additives are well-known to the skilled person.

In some embodiments, an ionic compatibilizer may be present or used. Suitable ionic compatibilizers can for instance be copolyesters prepared by using ionic monomer units as disclosed in WO 2011/031929 A2, page 5, incorporated herein by reference.

In the masterbatch embodiments of the present disclosure, the masterbatch of a copolyester-ether may be mixed or packaged with another masterbatch comprising the transition metal-based oxidation catalyst (a “salt and pepper” mixture). In some embodiments, the other masterbatch comprising the transition metal-based oxidation catalyst may further comprise a polyester.

In some embodiments, the polyester is a polyethylene terephthalate or a copolymer thereof having a melting point, determined according to ASTM D 3418-97, of about ≥240° C. to about ≤50° C., in particular about ≥242° C. to about ≤50° C., and especially about ≥245° C. to about ≤50° C.

In some embodiments, the polyester used in preparing the articles of the present disclosure has an intrinsic viscosity, measured according to the method described in Test Procedures section below, of about ≥0.6 dl/g to about ≤1.1 dl/g, in particular about ≥0.65 dl/g to about ≤0.95 dl/g.

Furthermore, the melting point difference, determined according to ASTM D 3418-97, between the polyester and the copolyester-ether is less than about 20° C. In some embodiments, the melting point difference is less than about 15° C., more specifically less than about 12° C. or less than about 10° C. In other embodiments, the melting point, determined according to ASTM D 3418-97, of the polyester is about ≥240° C. to about ≤50° C. and that of the copolyester-ether is about ≥225° C. to ≤50° C., in particular about ≥230° C. to about ≤50° C., especially about ≥232° C. to about ≤50° C. or about ≥240° C. to about ≤50° C. The melting points of the copolyester-ether and polyester may be determined for the starting materials or in the final composition.

The melting point of the copolyester-ether can be conveniently controlled by adjusting various characteristics or parameters of the polymer composition, as known to those skilled in the art. For instance, one skilled in the art may opt to suitably select the molecular weight of the polyether segment, and/or the weight ratio of polyester segment to polyether segment to adjust the melting point. It is also possible to select different types of polyester to adjust the melting point. For example, aromatic polyesters are known to have higher melting points than aliphatic polyesters. Thus, one skilled in the art may select or mix suitable polyesters to reliably adjust the melting point of the copolyester-ether. Other options include suitably selecting the type of polyether. For instance, the chain length and the presence or absence of a side chain influences the melting point of the copolyester-ether. A further possibility is the addition of additives. Another possibility is the molecular weight distribution obtained by combining or otherwise mixing varying copolyester-ethers to provide a melting range that may be in favor of thermal transitions suited to the article being formed.

The disclosed compositions, masterbatches and methods may be used for preparing articles of manufacture. Suitable articles include, but are not limited to, film, sheet, tubing, pipes, fiber, container preforms, blow molded articles such as rigid containers, thermoformed articles, flexible bags and the like and combinations thereof. Typical rigid or semi-rigid articles can be formed from plastic, paper or cardboard cartons or bottles such as juice, milk, soft drink, beer and soup containers, thermoformed trays or cups. In addition, the walls of such articles may comprise multiple layers of materials.

The term “comprising” encompasses “including” as well as “consisting” e.g. a composition “comprising” X may consist exclusively of X or may include something additional e.g. X+Y.

The following Examples demonstrate the present disclosure and its capability for use. The disclosure is capable of other and different embodiments, and its several details are capable of modifications in various apparent respects, without departing from the spirit and scope of the present disclosure. Accordingly, the Examples are to be regarded as illustrative in nature and non-limiting.

### Test Procedures

### Number Average Molecular Weight:

The number average molecular weight of the polyols is determined by the titration method for the hydroxyl number of the polyols. Similar ASTM methods are ASTM E222A and ASTM E222B, herein incorporated by reference.

A polyol sample is added into a 100 mL beaker 15 mL of dry tetrahydrofuran and the sample dissolved using a magnetic stirrer. 10 mL of p-toluenesulfonyl isocyanate in 250 mL anhydrous acetonitrile is then added to the solution. The solution is then stirred for five minutes after 1 mL of water is added. Then the solution is diluted to 60 mL with tetrahydrofuran and titrated with 0.1 N tetrabutyl ammonium hydroxide (TBAOH) using an automatic titrator. (TBAOH titrant: 100 mL 1M TBAOH/MeOH in 1000 mL isopropanol. Standardize against potassium biphthalate or benzoic acid standards. Re-standardize every time the electrode is recalibrated.)

The hydroxyl number of the polyol is calculated as followed:

$$Hydroxyl number ( OH \# ) = \frac{( V 2 - V 1 ) \cdot N \cdot 56.1}{sample weight}$$

Wherein,

V1=Titrant volume at first equivalence point (low pH)

V2=Titrant volume at second equivalence point (higher pH)

N=Normality of TBAOH

OH# is in the units of mg KOH/g glycol

The number molecular weight of the polyol is then calculated as followed:

$$Molecular weight ( number average ) = \frac{112200}{Hydroxyl number ( OH \# )} [ \frac{g}{mol} ]$$

Wherein, the numerator value of 112200 is calculated as,

56.1 (g/mol KOH M.Wt)×2 (mols OH/triol glycol)×1000 (mg/g)

### Intrinsic Viscosity:

The determination of the intrinsic viscosity (IV) is determined on a 0.01 g/mL polymer solution in dichloroacetic acid. The IV values are typically reported in the measurement units of deciliters per gram (dl/g). One deciliter is 100 ml or 100 cm³.

Before dissolution of solid state polymerized material, the chips are pressed in a hydraulic press (pressure: 400 kN at 115° C. for about 1 minute; type: PW40® Weber, Remshalden-Grunbach, Germany). 480 to 500 mg polymer, either amorphous chips or pressed chips, are weighed on an analytical balance (Mettler AT 400®) and dichloroacetic acid is added (via Dosimat® 665 or 776 from Metrohm) in such an amount, that a final polymer concentration of 0.0100 g/mL is reached.

The polymer is dissolved under agitation (magnetic stirring bar, thermostat with set point of 65° C.; Variomag Thermomodul 40ST®) at 55° C. (internal temperature) for 2.0 hrs. After complete dissolution of the polymer, the solution is cooled down in an aluminum block for 10 to 15 minutes to 20° C. (thermostat with set point of 15° C.; Variomag Thermomodul 40ST®).

The viscosity measurement is performed with the micro Ubbelohode viscometer from Schott (type 53820/11; Ø: 0.70 mm) in the Schott AVS 500® apparatus. The bath temperature is held at 25.00±0.05° C. (Schott Thermostat CK 101°). First the micro Ubbelohde viscometer is purged 4 times with pure dichloroacetic acid then the pure dichloroacetic acid is equilibrated for 2 minutes. The flow time of the pure solvent is measured 3 times. The solvent is drawn off and the viscometer is purged with the polymer solution 4 times. Before measurement, the polymer solution is equilibrated for 2 minutes and then the flow time of this solution is measured 3 times.

The relative viscosity (RV) is determined by dividing the flow time of the solution by the flow time of the pure solvent. RV is converted to IV using the equation:

IV (dl/g)=[(RV-1)×0.691]+0.063.

Determination of the thermal decomposition products detected in the preforms:

The decomposition products detected in the chips and preforms were measured via Headspace-GCMS. For the measurements 1 g of a powdered sample (particle size ≤1.0 mm) and 2 μL hexafluorisopropanol (HFIP) as the internal standard were added in 20 g vials and then incubated for 1 hour at 150° C. 1 μL of the headspace of the vials was injected in the column (RTX-5, crossbond 5% diphenyl/95% dimethyl polysiloxane, 60 m, 0.25 mm internal diameter) for separation. The main thermal decomposition products were detected and analyzed via mass spectrometer.

The following setup was used:

Gas Chromatograph (GC), Finnigan Focus GC (Thermo Electron Corporation)
SSL inlet
   Mode: Split
   Inlet T—230° C.
   Split flow—63 mL·min⁻¹
   Spilt ratio—70
Carrier
   Constant flow
Ramp from 40° C. (hold for 8 min) to 300° C. (hold for 3 min)
T increase 15° C. min⁻¹

Mass Spectrometer (MS), Finnigan Focus DSQ (Thermo Electron Corporation)
MS transfer line—T−250° C.
Ton source T 200° C.
Detector gain: 1.5·10⁵ (multiplier voltage 1445V)
Scan: 10-250 (mass range)

The following thermal decomposition products were detected in the headspace of the powdered samples:

C₂-bodies—acetaldehyde

C₃-bodies—formic acid propyl ester, propanol, propionaldehyde

C₄-bodies—tetrahydrofuran

The individual values for the above C₂- to C₄-bodies were summed up to give the reported value. The standard deviation of the thermal decomposition products is about 4% for all measurements.

### Thermal Behavior:

Melting temperature (Tₘ) is measured according to ASTM D 3418-97. A sample of about 10 mg is cut from various sections of the polymer chip and sealed in an aluminum pan. A scan rate of 10° C./min is used in a Netsch DSC204 instrument unit under a nitrogen atmosphere. The sample is heated from −30° C. to 300° C., held for 5 minutes and cooled to −30° C. at a scan rate of 10° C./min prior to the second heating cycle. The melting point (Tₘ) is determined as the melting peak temperature and is measured on the second heating cycle where the second heating cycle is the same as the first.

### Haze and Color:

The color of the chips and preform or bottle walls is measured with a Hunter Lab ColorQuest II instrument. D65 illuminant is used with a CIE 1964 10° standard observer. The results are reported using the CIELAB color scale, wherein L* is a measure of brightness (L* of 100=white; L* of 0.0=black), a* is a measure of redness (+) or greenness (−) and b* is a measure of yellowness (+) or blueness (−).

The haze of the bottle walls is measured with the same instrument (Hunter Lab ColorQuest II instrument). D65 illuminant is used with a CIE 1964 10° standard observer. The haze is defined as the percent of the CIE Y diffuse transmittance to the CIE Y total transmission. Unless otherwise stated the % haze is measured on the sidewall of a stretch blow molded bottle having a thickness of about 0.25 mm.

### Elemental Metal Content:

The elemental metal content of the ground polymer samples is measured with an Atom Scan 16 ICP Emission Spectrograph from Spektro. 250 mg of the copolyester-ether is dissolved via microwave extraction by adding 2.5 mL sulfuric acid (95-97%) and 1.5 mL nitric acid (65%). The solution is cooled, then 1 mL hydrogen peroxide is added to complete the reaction and the solution is transferred into a 25 mL flask using distilled water. The supernatant liquid is analyzed. Comparison of the atomic emissions from the samples under analysis with those of solutions of known elemental ion concentrations is used to calculate the experimental values of elements retained in the polymer samples.

### Oxygen Ingress Measurements—Non-Invasive Oxygen Determination (NIOD):

There are several methods available to determine the oxygen permeation, or transmission, into sealed packages such as bottles. In this case, non-invasive oxygen measurement systems (e.g., supplied by OxySense® and PreSens Precision Sensing) based on a fluorescence quenching method for sealed packages are employed. They consist of an optical system with an oxygen sensor spot (e.g. OxyDot®, which is a metal organic fluorescent dye immobilized in a gas permeable hydrophobic polymer) and a fiber optic reader-pen assembly which contains both a blue LED and photo-detector to measure the fluorescence lifetime characteristics of the oxygen sensor spot (e.g., OxyDot®).

The oxygen measurement technique is based upon the absorption of light in the blue region of the metal organic fluorescent dye of the oxygen sensor spot (e.g., OxyDot®), and fluorescence within the red region of the spectrum. The presence of oxygen quenches the fluorescent light from the dye as well as reducing its lifetime. These changes in the fluorescence emission intensity and lifetime are related to the oxygen partial pressure, and thus they can be calibrated to determine the corresponding oxygen concentration.

The oxygen level within a package such as a bottle can be measured by attaching an oxygen sensor spot (e.g., OxyDot®) inside the package. The oxygen sensor spot is then illuminated with a pulsed blue light from the LED of the fiber optic reader-pen assembly. The incident blue light is first absorbed by the dot and then a red fluorescence light is emitted. The red light is detected by a photo-detector and the characteristic of the fluorescence lifetime is measured. Different lifetime characteristics indicate different levels of oxygen within the package.

Experimental Method with PET Bottle at Ambient Conditions (23° C.):

A PreSens non-invasive and non-destructive oxygen ingress measurement equipment (Fibox 3-trace meter, fiber optic cable and trace oxygen sensor spots) is used to determine the oxygen permeability of the bottle at room temperature (23° C.). For a typical shelf-life test, the trace oxygen sensor spot is first attached onto the inner side wall of a 500 ml transparent PET bottle. The bottle is then filled with deionized and deoxygenated water containing AgNO₃ up to a headspace of approx. 20 ml, inside a nitrogen circulation glove box where the oxygen level of the water inside the bottle is stabilized at a level well below 50 ppb. These bottles were then stored in a conditioning cabinet (Binder 23° C., 50% relative humidity) and the oxygen ingresses were monitored as a function of time using the PreSens oxygen ingress measurement equipment.

At a given time of measurements, an average value is first obtained from about 10 readings taken on the output of the trace oxygen spot for each bottle. This is then repeated for all the 5 bottles so as to achieve an overall averaged value for the oxygen ingress through the formulated cap and the wall of the bottle.

Oxygen measurements are made at predetermined day counts, e.g. day 0 (start), 1, 2, 3, 7, 14, 21, 28, 42, 56, and so on. The average oxygen ingress is determined and reported as ppb as follows:

$$Oxygen ingress [ ppb ] = \frac{\sum Oxygen ingress in the measurement of that day [ ppb ]}{\sum Amount of measurements up to the day of {measurement}^{*}}$$

$${}^{*} Including day 0$$

### Preform and Bottle Process:

Unless otherwise stated, the barrier copolyester-ether of the present disclosure is dried for about 24 hours at 110-120° C. under nitrogen atmosphere, blended with the dry base resin which contains the transition metal catalyst, melted and extruded into preforms. Each preform for a 500 mL bottle specimen, for example, employs about 28 grams of the resin. The preform is then heated to about 85-120° C. and stretch-blown into a 500 mL contour bottle at a planar stretch ratio of approx. 8. The stretch ratio is the stretch in the radial direction times the stretch in the length (axial) direction. Thus if a preform is blown into a bottle, it may be stretched about two times in the axial direction and stretched up to about four times in the hoop direction giving a planar stretch ratio of up to eight (2×4). Since the bottle size is fixed, different preform sizes can be used for obtaining different stretch ratios. The sidewall thickness of the bottles is >0.25 mm. The oxygen permeation or ingress through these bottles is measured. For reasons of better grindability, the thermal decomposition products are detected in the ground preforms.

### Materials Used in the Examples:

Purified terephthalic acid (PTA; Chemical Abstract Registry CAS No. 100-21-0), is used in the examples of the present disclosure. Monoethylene Glycol, EG or MEG (CAS No. 107-21-1), is used in the examples of the present disclosure. The product specification of EG is minimum 99.9% purity by weight.

A titanium catalyst, TI-Catalyst C94, as used in the examples of the present disclosure, is manufactured by Sachtleben Chemie GmbH (Germany). The titanium content in the catalyst is 44% by weight.

A commercial-grade, INVISTA Terathane® 1400 Poly (tetramethylene ether) Glycol or PTMEG 1400 is used in the examples of the present disclosure. Terathane® 1400 has a number average molecular weight of 1400 g/mole, stabilized with 200-350 ppm BHT (CAS No. 128-37-0).

A commercially available antioxidant, Ethanox® 330 (CAS No. 1709-70-2), is used in the examples of the present disclosure, such as that manufactured by SI Group. Typical commercial purity of Ethanox® 330 is greater than 99% by weight.

An industrial hindered amine light stabilizer HALS, Uvinul® 4050 (CAS No. 124172-53-8), as used in the examples of the present disclosure, is manufactured by BASF. Uvinul® 4050, i.e., N,N′-bisformyl-N,N′-bis-(2,2,6,6-tetramethyl-4-piperidinyl)-hexamethylendiamine, is a sterically hindered monomeric amine with the molecular mass of 450 g/gmol.

Cobalt stearate (CAS No. 1002-88-6), as used in the examples of the present disclosure, is manufactured and supplied by OM Group under the “Manobond CS95” product name. The cobalt content in Manobond CS95 is 9.3-9.8% by weight and the melt point of Manobond CS95 is in the range of 80 to 95° C.

Sodium stearate (CAS No. 68424-38-4), as used in the examples of the present disclosure, is supplied by Peter Greven GmbH & Co. KG, Germany, under the “Ligastar NA R/D” product trade name. The sodium content in Ligastar NA R/D is about 6% by weight.

Magnesium stearate (CAS No. 557-04-0), as used in the examples of the present disclosure, is supplied by Peter Greven GmbH & Co. KG, Germany, under the “Ligastar MG 700” product trade name. The magnesium content in Ligastar MG 700 is about 4.4% by weight.

Solvaperm Yellow 2G (CAS No. 7576-65-0) with the color index of Solvent Yellow 114, as used in the examples of the present disclosure, is a registered product trademark of Clariant Chemicals.

An INVISTA Polymer and Resins product brand, Polyclear PET 1101, as used in the examples of the present disclosure, is a commercial grade copolymer packaging resin with a nominal intrinsic viscosity (IV) of 0.83±0.02 dL/g (measured as 1% solution in dichloroacetic acid) and contains isophthalic acid (IPA). This grade is typically used in carbonated soft drink (CSD) bottles, packaging and other injection/stretch-blow molded applications.

### EXAMPLES

### Example 1—Copolyester-Ether (COPE) Preparation

The base resin, copolyester-ether (COPE) is prepared using continuous polymerization process: Direct esterification of terephthalic acid (PTA) and monoethylene glycol (EG) in a small molar excess of glycol (about 1.10:1 EG:PTA molar ratio) is performed in a primary esterification reactor at 250-260° C. and under normal pressure in the presence of titanium catalyst C94. Terathane® PTMEG 1400, at about 35 wt % based on the final copolyester-ether polymer weight, is added after esterification and the mixture is stirred for about 1 hour. Uvinul® 4050 is added late to the esterification reaction mixture and shortly before the start of polycondensation.

During the polycondensation step, the elimination of glycol under reduced pressure is started with the final polycondensation temperature in the 255-260° C. range. The final polycondensation pressure is about 1 mbar. Excess glycol is distilled out of the reaction mixture under increased temperature and reduced pressure until the desired polymerization degree is achieved. The desired polymer melt is flowed through the reactor discharge pump in a cooling bath with deionized water. After the polymer strand is cooled underwater, it is pelletized with Pell-tec pelletizer.

The intrinsic viscosity of the final copolyester-ether polymer compositions is in the 0.600 to 0.850 dl/g range. In one embodiment, a 1000 kg of COPE product may be prepared using following component quantities as listed in Table 1.

TABLE 1

| Component | Amount, kg |
|---|---|
| Terephthalic Acid | 562 |
| Ethylene Glycol | 231 |
| Terathane ® 1400 | 350 |
| Uvinul ® 4050 | 2.0 |
| Ethanox ® 330 | 0.50 |
| Catalyst - C94 | 0.350 |
| Anti-foam agent | <0.5 |

### Example 2—Cobalt-Stearate Masterbatch (Co-MB) Preparation

A PTA-based polymer, as used herein, is a commercial polyethylene terephthalate (PET) polyester product of INVISTA Resins and Fibers with the “XPURE® Polyester 7090” product name. The XPURE® Polyester 7090 is prepared according to the similar direct esterification method described in Example 1. The PET polymer resin is dried at 150-160° C. under vacuum for 4-6 hours with dry air (<−30° C. dew point) to attain 50 ppm (max.) residual moisture content.

Cobalt stearate, sodium stearate, magnesium stearate, and Solvaperm Yellow 2G are added directly in the melt extrusion step. The melt extruder used is a co-rotating, 27 mm extruder screw diameter and screw length to diameter (L:D) ratio of 36:1, for example, Leistritz Micro 27 36D model melt extruder. The polymer processing rate is about 8 kg/hr. Stage-wise operating temperatures are: water at room temperature (T₀), 230° C. (T₁), 254° C. (T₂), 256° C. (T₃), 253° C. (T₄-T₅), 255° C. (T₆-T₇) and 260° C. (T₈-T₉). The desired molten material is extruded into a cooling water bath with deionized water. The cooled polymer strands are pelletized with Pell-tee pelletizer into typical cylindrical granules of about 2 mm diameter and about 3 mm length.

Either of the cobalt and/or dye levels in the final Cobalt-Stearate Masterbatch (Co-MB) composition could be varied by adjusting the amounts of cobalt stearate and/or Solvaperm Yellow 2G dye, respectively.

The intrinsic viscosity of the final Co-MB polymer composition is greater than 0.45 dl/g. In one embodiment, a 1000 kg of Co-MB product may be prepared using the following components quantities as listed in Table 2.

TABLE 2

| Component | Amount, kg |
|---|---|
| XPURE ® Polyester 7090 | 907.2 |
| Cobalt Stearate | 42.9 |
| Sodium Stearate | 26.0 |
| Magnesium Stearate | 23.9 |
| Solvaperm Yellow 2G | 0.06 |

### Example 3—Mixing of COPE and Co-MB

The white or off-white “salt” pellets of COPE, prepared according to the Example 1 method, are mixed with the dark “pepper” pellets of Co-MB, prepared according to the Example 2 method, to form a two-chip component mixture referred to as “salt and pepper” mixture. Prior to mixing the two, both COPE and Co-MB pellets are dried at about 85° C. under vacuum for about 8 hours to remove residual moisture. The salt and pepper mixture may be mixed with the additional dye colorant and/or cobalt compound depending on the final cobalt and dye levels to be achieved.

It is noted here that the mixed composition, as prepared via Examples 1-3, can optionally be varied to yield different levels of Cobalt; a catalytic part of this active formulation effective as oxygen barrier protection for food and beverage containers. However, increasing cobalt levels may impart increasing blue coloration in such applications. This may be masked by using a colorant dye, such as Solvaperm Yellow 20, in the oxygen barrier compounded composition, according to Examples 1-3. The levels of these two components, cobalt and dye, are measured against visual properties of the containers using a standard colorimeter which generates values for lightness or darkness of the plastic (L* value); red or green tint (a* value), and blue or yellow (b* value). The following examples illustrate these various effects.

### Examples 4 (a-c)—Effect of Cobalt Level on Oxygen Ingress

A base “Polyclear® PET 1101” resin is mixed with a “salt and pepper” composition of COPE and Co-MB, prepared according to Examples 1-3, along with the additional dye colorant and/or cobalt compound depending on the final cobalt and dye levels to be achieved. The amount of Co-MB portion is varied to give increased cobalt level in the final composition. Table 3 represents the measured oxygen ingress levels after 28 days and 56 days for stretch-blow molded bottles filled on Day 0 (start of test).

TABLE 3

| | 4(a) | | 4(b) | | 4(c) | |
|---|---|---|---|---|---|---|
| Base Resin (PET 1101) | 94.75 | wt % | 94.24 | wt % | 93 | wt % |
| COPE | 3.5 | wt % | 3.5 | wt % | 3.5 | wt % |
| Storage time for | 2 | days | 2 | days | 1 | day |
| preform before blown | | | | | | |
| into a bottle | | | | | | |

| Cobalt Level (ppm) = | 72 | 94 | 197 |
|---|---|---|---|
| Days from filling | Oxygen Ingress (ppb) | | |
| 0 (start) | 19.8 | 22.1 | 19.2 |
| 28 | 751.7 | 5024 | 123.2 |
| 56 | 1087.8 | 660.7 | 213.0 |

The base resin (PET 1101), COPE and Co-MB weight portions, used relative to the final composition, are as shown in Examples 4(a, b, c). Each final composition, according to the Examples 4(a, b, c), is injection-molded into preforms and further stretch-blow molded into 500 mL, 28 g bottles. The preforms made from the compositions in Examples 4(a) and 4(b) are stored for 2 days before stretch-blowing into bottles. For Example 4(c), the storage time for preform is 1 day before stretch-blowing into a bottle. In Reference Example 4(a), the reference composition is prepared to contain about 72 ppm cobalt level.

The data indicates that increasing cobalt levels above 72 ppm, and particularly above 90 ppm as in Examples 4(b) and 4(c), are effective for improved oxygen barrier properties in these compositions.

### Examples 5—Compositions with Improved Oxygen Barrier Properties

An increase in the cobalt level in the total composition may improve oxygen barrier performance. However, increasing the cobalt level may also impact the visual properties of the final composition in the bottle, particularly decreasing the L* and b* values while increasing the a* value. Therefore there may be a need to counter-balance the increase in a* and the decrease in b* by adding a colorant dye.

Compositions are prepared according to the methods described in Example 1-3 and of varying cobalt content between 60-200 ppm, Solvaperm Yellow 2G dye level between 1-6 ppm and before-use storage time periods of between 1 to 14 days. The portion of COPE, prepared according to the Example 1 method, in the final polymer resin is targeted to about 2.9 wt %. Terathane® 1400 in the COPE composition, prepared according to the Example 1 method, is about 35 wt % level. The starting Co-MB composition, prepared according to the Example 2 method, contains about 60 ppm of the Solvaperm Yellow 2G dye.

It may be desired to determine a bottle formulation that has marketable visual properties in addition to the improved oxygen barrier protection. Increasing levels of cobalt creates a blue color in the bottle and offsetting this with a yellow dye can grey or otherwise create a yellow/grey effect.

### Example 6—Effect of Storage Time

The storage time dependence of preforms and bottles on oxygen barrier performance of bottles is studied in these examples. The preforms are stored for several days prior to stretch blow molding into bottle specimens which are then used for oxygen ingress measurements. Similar to this, bottles are immediately blown from preforms and stored for several days prior to oxygen ingress measurements.

The oxygen ingress into bottles over time for storage times of 0, 1, 2, and 7 days for preforms and bottles is measured while varying the cobalt content in the composition to within 90-150 ppm and by maintaining the dye level of about 3.0 ppm.

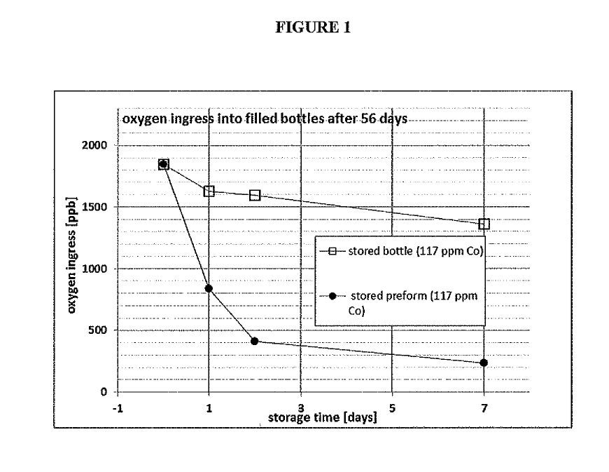

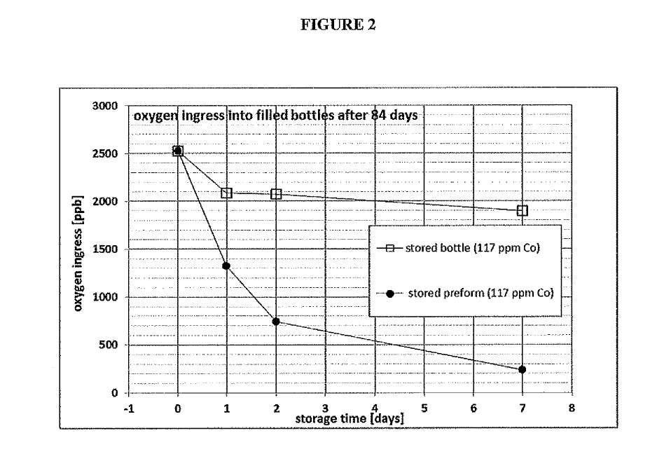

FIGS. 1 and 2 represent various embodiments of the present disclosure, wherein the measured cobalt levels of about 117 ppm is maintained at the dye level of about 3.0 ppm in the compositions prepared via Example 1-3. In FIG. 1, the measured oxygen ingress (ppb), after 56 days from the filling of the bottles is plotted on the Y-axis and storage time in days for stored preforms (circle symbols) and bottles (square symbols) is plotted on the X-axis.

In FIG. 2, the measured oxygen ingress (ppb), after 84 days from the filling of the bottles is plotted on the Y-axis and storage time in days for stored preforms (circle symbols) and bottles (square symbols) is plotted on the X-axis.

Table 4 represents the oxygen ingress (ppb) into bottles, measured after 56 days and after 84 days, and for preform and bottle storage times of 0, 1, 2, and 7 days. The cobalt content in the composition is varied within 90-150 ppm and the dye level of about 3.0 ppm is maintained.

TABLE 4

| Base Resin (PET 1101) | 93.97 wt % | | | |
|---|---|---|---|---|
| COPE | 3.14 wt % | | | |
| Cobalt Level (ppm) = | 117 | | | |
| Dye Level (ppm) = | 3.0 | | | |
| | Oxygen Ingress | | Oxygen Ingress | |
| | (ppb) after 56 days | | (ppb) after 84 days | |
| | 6(a) | 6(b) | 6(c) | 6(d) |
| Storage Time, days | Preform | Bottle | Preform | Bottle |
| 0 | 1845 | 1845 | 2522 | 2522 |
| 1 | 836.4 | 1627.9 | 1324 | 2089 |
| 2 | 412.1 | 1595.0 | 741 | 2076 |
| 7 | 235.7 | 1360.0 | 239 | 1893 |

The visual properties measured on day 0 for the Example 6(a) composition are L*=86.4, a*=−0.66, b*=4.19 and haze=3.8.

It is surprising that bottles immediately blown from the preforms and filled provide no oxygen barrier irrespective of the storage time; all specimens show higher than 1000 ppb oxygen ingress after 56 days (square symbols in FIG. 1) and higher than 1500 ppb oxygen ingress after 84 days (square symbols in FIG. 2). Surprisingly and unexpectedly, the measured oxygen ingress for bottles blown of stored preforms (circle symbols in FIG. 1 and in FIG. 2) is lower than that measured for the bottles at all storage times. The storage time of at least 1 day for preforms before stretch-blowing into bottles may be sufficient to observe an improvement in oxygen barrier properties.

### Example 7—Improved Oxygen Barrier Properties Anti Visual Properties for Bottles

Preforms that are prepared using the COPE and CoMB compositions and mixing, according to the Example 1-3 methods, contain about 90 to 150 ppm cobalt and about 2.5 to 3.0 ppm dye level. The preforms are stored for a minimum of 7 days. The preforms are then stretch-blown into bottle specimens, filled and the oxygen ingress performance is measured over time. The visual properties of bottle specimens are also evaluated for L*, a*, b*, and haze.

It is to be noted here that the adequate oxygen barrier protection may be designed depending on a particular storage application.

### Example 8—Additives in the Composition Comprising Copolyester-Ether

Table 5 represents the compositions, prepared according to the Example 1 method, comprising various HALS types and levels.

TABLE 5

| Sample | 1 | 2 | 3 | 4 | 5 | 6 | 7 | 8 | 9 | 10 | 11 | 12 | 13 |
|---|---|---|---|---|---|---|---|---|---|---|---|---|---|
| HALS¹ | — | Uvinul ® 4050 | | | | | Uvinul ® 5050 | | | Uvinul ® 5062 | | | |
| Total | — | 156 | 313 | 625 | 1250 | 2500 | 1513 | 3025 | 6050 | 781 | 1563 | 2500 | 3125 |
| amount | | | | | | | | | | | | | |
| [ppm] | | | | | | | | | | | | | |

¹Uvinul ® 4050 (N,N′-bisformyl-N,N′-bis-(2,2,6,6-tetramethyl-4-piperidinyl)-hexamethylendiamine), CAS: 124172-53-8
Uvinul ® 5050 (sterically hindered amine, oligomeric), CAS: 152261-33-1
Uvinul ® 5062 (sterically hindered amine, oligomeric), CAS: 65447-77-0

Table 6 represents the compositions, prepared according to the Example 1 method, comprising various additives by types and levels.

TABLE 6

| Sample | 14 | 15 | 16 | 17 | 18 | 19 | 20 | 21 | 23 |
|---|---|---|---|---|---|---|---|---|---|
| Additive | UV-absorber¹ | | | | Thermo-oxidative stabilizer² | | | | |
| | Hostavin ® | Tinuvin ® | Tinuvin ® | Uvinul ® | Hostanox ® | | Ethanox ® 330 | | |
| | Aro8 | 234 | 1577 | 3030 | PEP-Q | | | | |
| [ppm] | 2500 | 2500 | 2500 | 2500 | 200 | 625 | 625 | 1250 | 2500 |

Thermal decomposition products (ppm, detected in the resin)

| | | | | | | | | | |
|---|---|---|---|---|---|---|---|---|---|
| C₂-C₄ | 1971 | 1884 | 2314 | 2098 | 2288 | 1996 | 54 | 52 | 46 |
| decomp. | | | | | | | | | |

¹Hostavin ® Aro8 (2-Hydroxy-4-n-octyloxybenzophenone), CAS: 1843-05-6
Tinuvin ® 234 (2-(2H-Benzotriazol-2-yl)-4,6-bis(1-methyl-1-phenylethyl)phenol, CAS: 70321-86-7
Tinuvin ® 1577 (2-(4,6-diphenyl-1,3,5-triazin-2-yl)-5-[(hexyl)oxy]-phenol, CAS: 147315-50-2
Uvinul ® 3030 (2-Propenoic acid, 2-cyano-3,3-diphenyl-,2,2-bis[[(2-cyano-1-oxo-3,3-diphenyl-2-propenyl)oxy]methyl]-1,3-propanediyl ester), CAS: 178671-58-4
²Hostanox ® PEP-Q (Diphosphonite antioxidant), CAS: 119345-01-6
Ethanox ® 330 (1,3,5-trimethyl-2,4,6-tris(3,5-di-t-butyl-4-hydroxybenzyl)benzene, CAS: 1709-70-2

Tables 7 and 8 represent the compositions, prepared according to the Example 1 method, comprising various additives by types and levels.

TABLE 7

| Sample | I | II | III | IV | V |
|---|---|---|---|---|---|
| Stabilizer | — | Uvinul ® | Hostavin ® | Hostanox ® | Ethanox ® |
| | | 4050 | Aro8 | PEP-Q | 330 |
| Amount stabilizer | — | 2500 | 2500 | 2500 | 625 |
| (added to the | | | | | |
| Copolyester-ester | | | | | |
| resin) [ppm] | | | | | |
| Oxygen Ingress after | 11 | 23 | 32 | 95 | 226 |
| 56 days (measured in | | | | | |
| the bottles) [ppb] | | | | | |

TABLE 8

| | | | | | |
|---|---|---|---|---|---|
| Sample | I | II | VI | VII | VIII |

| | | |
|---|---|---|
| Stabilizer | — | Uvinul ® 4050 |

| | | | | | |
|---|---|---|---|---|---|
| Amount stabilizer | — | 2500 | 1250 | 625 | 313 |
| (added to the | | | | | |
| Copolyester-ester | | | | | |
| resin) [ppm] | | | | | |
| Oxygen Ingress after | 11 | 23 | 26 | 27 | 12 |
| 56 days (measured in | | | | | |
| the bottles) [ppb] | | | | | |

1. A composition comprising a) a copolyester-ether, and b) a monomeric, oligomeric or polymeric hindered amine light stabilizer (HALS) in an amount of ≥15 ppm to ≤20,000 ppm, on basis of the weight of the stabilizer in the composition, wherein the copolyester-ether comprises one or more polyester segments and one or more polyether segments, wherein the one or more polyether segments are present in an amount of about ≥5 to about 95 wt.-% of the copolyester-ether; wherein the HALS is represented by the formula (I) or a mixture of compounds of formula (I), 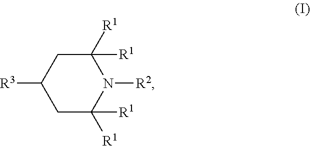
wherein each R1 independently represents C1-C4 alkyl, R2 represents H, C1-C4 alkyl, OH, O—C1-C4 alkyl, or a further part of an oligomeric or polymeric HALS, and R3 represents a further part of a monomeric, oligomeric or polymeric HALS.

2. The composition of claim 1, wherein the polyether segment is a linear or branched poly (C2-C6-alkylene glycol) segment.

3. The composition of claim 1, wherein the polyether segment has a number-average molecular weight of about ≥200 to about ≤5000 g/mol, preferably about ≥600 to about ≤3500 g/mol.

4. The composition of claim 1, wherein the polyether segments are present in the copolyester-ether in an amount of about ≥15 to about ≤45 wt %.

5. The composition of claim 1, wherein the copolyester-ether comprises a polyethylene terephthalate (co)polyester segment.

6. The composition of claim 1, wherein the HALS is a monomeric HALS, or a mixture thereof.

7. The composition of claim 1, wherein the HALS has a molecular weight of ≥400 g/mol or above.

8. The composition of claim 1, further comprising an antioxidant.

9. The composition of claim 8, wherein the antioxidant is selected from group consisting of hindered phenols, sulfur-based antioxidants, and phosphites.

10. The composition of claim 8, wherein the antioxidant is present in the composition in an amount of up to about ≤3000 ppm.

11. The composition of claim 9, wherein the antioxidant is a hindered phenol.

12. The composition of claim 8, wherein the antioxidant is

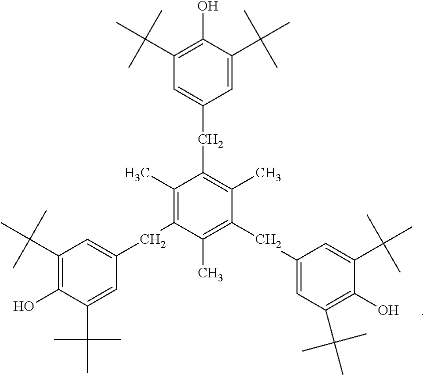 [SMILES: Cc1c(Cc2cc(C(C)(C)C)c(O)c(C(C)(C)C)c2)c(C)c(Cc2cc(C(C)(C)C)c(O)c(C(C)(C)C)c2)c(C)c1Cc1cc(C(C)(C)C)c(O)c(C(C)(C)C)c1]

13. A composition comprising a) a copolyester-ether, and b) an antioxidant, wherein the copolyester-ether comprises one or more polyester segments and one or more polyether segments, wherein the one or more polyether segments are present in an amount of about ≥5 to about ≥95 wt. % of the copolyester-ether.

14. The composition of claim 13, wherein the polyether segment is a linear or branched poly (C2-C6-alkylene glycol) segment.

15. The composition of claim 13, wherein the polyether segment has a number-average molecular weight of about ≥200 to about ≤5000 g/mol, preferably about ≥600 to about ≤3500 g/mol.

16. The composition of claim 13, wherein the polyether segments are present in the copolyester-ether in an amount of about ≥15 to about ≤45 wt. %.

17. The composition of claim 13, wherein the copolyester-ether comprises a polyethylene terephthalate (co)polyester segment.

18. An additive composition comprising:
a) no more than ≤75 parts by weight of a polyester;
b) no less than ≥25 parts by weight of a copolyester-ether,
wherein the copolyester-ether comprises one or more polyester segments and one or more polyether segments, wherein the one or more polyether segments are present in an amount of about ≥5 to about ≤95 wt.-% of the copolyester-ether;
c) a transition metal-based oxidation catalyst;
d) a monomeric, oligomeric or polymeric hindered amine light stabilizer (HALS) in an amount of ≥15 ppm to 20,000 ppm, on basis of the weight of the stabilizer in the total composition, wherein the HALS is represented by the formula (I) or a mixture of compounds of formula (I), 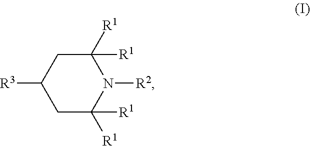
wherein each R1 independently represents C1-C4 alkyl, R2 represents H, C1-C4 alkyl, OH, O—C1-C4 alkyl, or a further part of an oligomeric or polymeric HALS, and R3 represents a further part of a monomeric, oligomeric or polymeric HALS; and
e) optionally, a colorant.

19. The additive composition of claim 18, wherein the transition metal is selected from the group consisting of cobalt, manganese, copper, chromium, zinc, iron, and nickel.

20. The additive composition of claim 19, wherein the transition metal is cobalt.

21. The additive composition of claim 18, further comprising an antioxidant.

22. The additive composition of claim 18, wherein the colorant is selected from the group consisting of a yellow dye, a red dye and blue dye.

23. The additive composition of claim 22, wherein the colorant is a yellow dye.

24. The additive composition of claim 18, wherein the transition metal is present in the composition in an amount of at least about ≥1,000 ppm.

25. The additive composition of claim 18, wherein the colorant is present in the composition in an amount up to ≤500 ppm.

26. A blend composition comprising the additive composition of claim 18, a base polyester, and optionally, a second colorant.

27. The blend composition of claim 26, comprising ≥80-≤98.5 parts by weight of the first and the second base polyesters; ≥0.5-≤20 parts by weight of the copolyester-ether, the monomeric, oligomeric or polymeric HALS in an amount of ≥15 ppm-≤20,000 ppm, on basis of the weight of the stabilizer in the blend composition

28. The blend composition of claim 27, wherein the transition metal is present in the composition in an amount of at least ≥80 ppm.

29. The blend composition of claim 27, wherein the colorant is present in the composition in an amount up to ≤10 ppm.

30. A method of improving oxygen barrier properties of an article comprising storing a preform comprising the composition in claim 18, wherein the storage time is sufficient to observe an improvement in oxygen barrier properties.
